(19) United States
(12) Patent Application Publication
(10) Pub. No.: US 2013/0114870 A1
(43) Pub. Date: May 9, 2013

(54) MEDICAL IMAGING FOR DRUG APPLICATION ANALYSIS

(71) Applicant: Aris Mardirossian, Potomac, MD (US)

(72) Inventor: Aris Mardirossian, Potomac, MD (US)

(73) Assignee: Patents Innovations, LLC, Venice, FL (US)

(21) Appl. No.: 13/289,726

(22) Filed: Nov. 4, 2011

(51) Int. Cl. G06K 9/62

(52) U.S. Cl. 382/131; 382/128

(57) ABSTRACT

A system is presented that improves current medical imaging analysis systems. The system acquires medical image data of a patient and links the medical image data to the patient's personal information and the particular drugs a patient is using for treating a clinically diagnosed illness. The system can then associate the information and attempt to match it to information stored in a medical imaging database to help the medical personnel diagnose the patient's illness and determine which drugs are likely to help the patient or likely to have certain side effects on the patient.

### BACKGROUND AND SUMMARY OF EXAMPLE EMBODIMENTS

Medical imaging technology, such as X-ray devices, CT scanning devices, MRI devices, and PET scanning devices are commonly used to diagnose particular illnesses for a patient. These devices allow medical personnel to obtain an image of the patient's internal organs without performing invasive procedures. The medical images can be captured, transmitted, and stored in a central database using a picture archiving and communication system (PACS), for example.

Recently, medical personnel have been comparing medical images of a patient to those stored in a database for the purposes of obtaining a clinical diagnosis. For example, a medical image of a patient's brain may show similarities to several patients that have been diagnosed with Alzheimer's. Without performing any invasive procedures, the medical personnel can help diagnose the patient's illness by comparing his/her medical image to a database of stored medical images.

Treating certain health issues is still an inexact science. In particular, mental health issues are very difficult for medical personnel to diagnose and treat. Even though medical imaging technology can be used to diagnose certain illnesses, there are several drawbacks when it comes to diagnosing mental health issues of a patient. Likewise, there are also many drawbacks in, and unknowns associated with, determining which particular drugs work for a patient and what drugs have certain side effects for a patient.

Thus, it will be appreciated that there is a need for an improved medical imaging analysis system that can take into account the drawbacks of the current technology.

In certain example embodiments, a system is presented that improves current medical imaging analysis systems. The system acquires medical image data of a patient and links the medical image data to the patient's personal information and the particular drugs a patient is using for treating a clinically diagnosed illness. The system can then associate the information and attempt to match it to information stored in a medical imaging database to help the medical personnel diagnose the patient's illness and determine which drugs will help the patient or will have certain side effects on the patient.

According to an aspect of certain example embodiments, a method for analyzing medical image data using a computer processing system having one or more processors is provided. The method includes acquiring medical image data of a first subject, acquiring medical information related to the first subject, associating the medical information and the medical image data with a drug used by the first subject, comparing the medical image data, the medical information, and the drug used to stored medical image data, stored medical information, and stored drug use of a second subject, determining if the medical image data, the medical information, and the drug used match the stored medical image data, the stored medical information, and the stored drug use of the second subject, and generating a report for diagnosing/treating the first subject based on the determined match.

According to another aspect of certain example embodiments, a medical imaging analysis system for analyzing medical image data is provided, the medical imaging analysis system has a scanning device and an information processing device. The scanning device has an image capture unit for capturing image data of a first subject, and a data relay unit configured to relay the captured image data. The information processing device has a data relay unit configured to receive the relayed captured image data, a memory for storing a medical database, and a medical analysis unit having one or more processors. The medical analysis unit is configured to acquire medical image data of the first subject, acquire medical information related to the first subject, associate the medical information and the medical image data with a drug used by the first subject, compare the medical image data, the medical information, and the drug used to stored medical image data, stored medical information, and stored drug use of a second subject, determine if the medical image data, the medical information, and the drug used match the stored medical image data, the stored medical information, and the stored drug use of the second subject, and generate a report for diagnosing/treating the first subject based on the determined match.

According to another aspect of certain example embodiments, an information processing device used for analyzing medical image data is provided. The information processing device has a data relay unit configured to receive captured image data relayed from an image capturing device, a memory for storing a medical database, and a medical analysis unit having one or more processors. The medical analysis unit is configured to acquire medical image data of a first subject, acquire medical information related to the first subject, associate the medical information and the medical image data with a drug used by the first subject, compare the medical image data, the medical information, and the drug used to stored medical image data, stored medical information, and stored drug use of a second subject, determine if the medical image data, the medical information, and the drug used match the stored medical image data, the stored medical information, and the stored drug use of the second subject, and generate a report for diagnosing/treating the first subject based on the determined match.

According to another aspect of certain example embodiments, there is provided a method of diagnosing a patient. A scan of the patient's brain is received. The scan of the patient's brain is compared, via at least one processor, to pre-treatment baseline scans of other patients' brains. One or more similar pre-treatment baseline scans is/are identified. One or more likely effective treatment regimens is/are determined based on the one or more identified similar pre-treatment baseline scans. Data indicative of the one or more likely effective treatment regimens is outputted. According to certain example embodiments, the scan may be a PET scan, and the comparing may include, for example, looking for similar color patterns as between the scan of the patient's brain and the pre-treatment baseline scans of the other patients' brains.

In certain example implementations, the medical image data, the medical information, and the drug used are stored in the medical database after the medical information and the medical image data are associated with the drug used by the first subject and without comparing, determining, or generating the report.

In certain example implementations, the report includes information relating to a subject name, a clinical diagnosis, a drug administered, image colors of the medical image data, percentage of image colors in the medical image data, and a thumbnail of the medical image data for the first and second subjects.

In certain example implementations, the scanning device is at least one of a PET scanning device, a CT scanning device, and an MRI scanning device.

In certain example implementations, a non-transitory computer-readable storage medium having computer readable code embodied therein for executing the method for analyzing medical image data is provided.

In certain example implementations, the medical information is acquired at the scanning device, and the scanning device relays both the medical image data and the medical information to the information processing device.

In certain example implementations, the medical information is acquired at the information processing device.

The features, aspects, and advantages described above may be combined in any suitable combination or sub-combination to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a diagram of an example embodiment of the medical imaging system;

FIG. 2 is an example embodiment of medical images taken by the medical imaging system;

FIG. 3 shows an example of a table storing information in the medical image analysis system;

FIG. 4 depicts a block diagram of the medical image analysis system; and

FIG. 5 shows an exemplary flowchart describing the processes carried out by the medical image analysis system.

### DETAILED DESCRIPTION OF CERTAIN EXAMPLE EMBODIMENTS

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc., are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on non-transitory computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., at least one processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

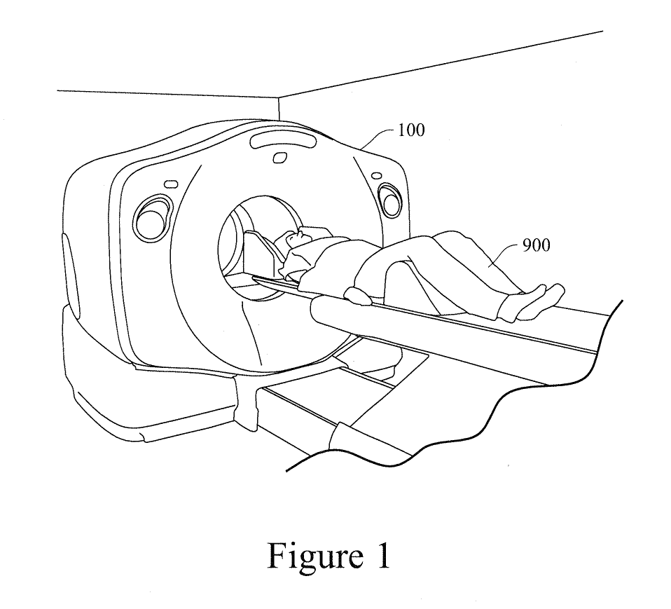

FIG. 1 shows a diagram of an example medical imaging system 100. The medical imaging system 100 can be, for example, a positron emission tomography (PET) scanning device, a computed tomography (CT) scanning device, a magnetic resonance imaging (MRI) device, an X-ray device, an electrocardiography (EKG) device, or an ultrasound device. Of course, the medical imaging system 100 is not limited to these examples and may include any one or more types of imaging systems.

In FIG. 1, a patient 900 enters inside the medical imaging system 100. In certain example embodiments, the patient 900 may lie on a bed or some type of flat surface and equipment will slide the bed into an opening of the medical imaging system 100.

Once inside, the medical imaging system 100 will perform an imaging operation on the patient 900. The medical imaging system 100 is configured to perform imaging on any portion of the patient 900 body. In certain example embodiments, the medical imaging system 100 will capture a medical image of internal organs (e.g., brain) of a head of the patient 900. This imaging technology is advantageous, as it allows medical personnel to examine the internal organs of the patient 900 without any sort of invasive procedure.

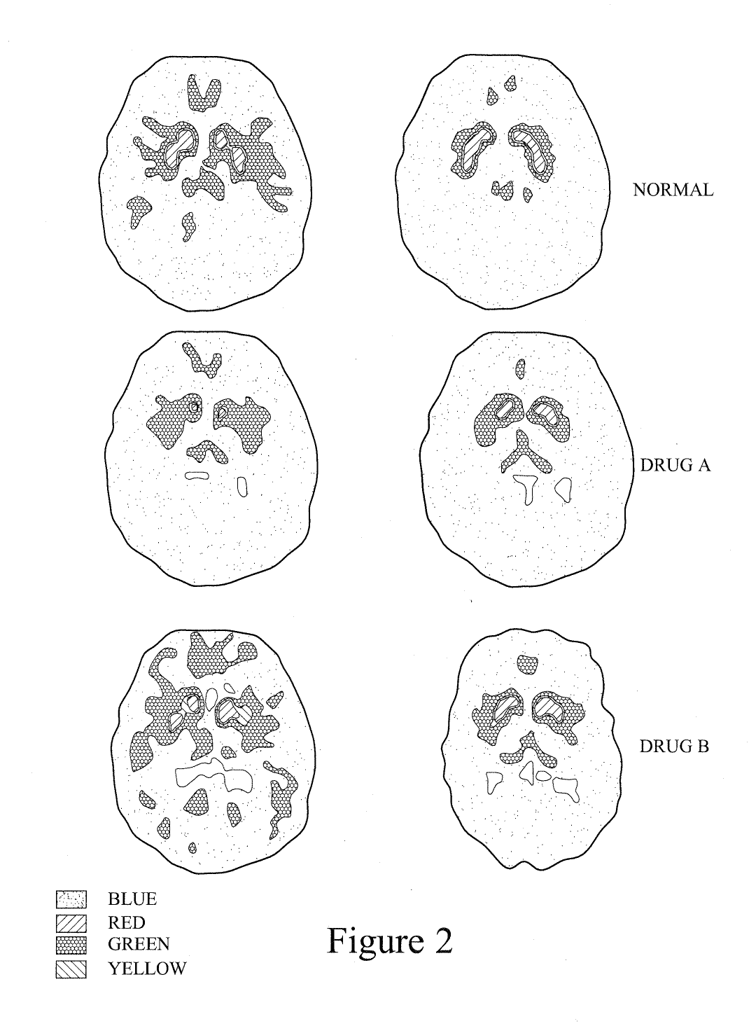

FIG. 2 shows example diagrams of medical images taken by the medical imaging system 100. In this example embodiment, the diagrams of the medical images show different images of brain scans of one or more patients. The top row of brain scan diagrams show a brain scan of a healthy patient that has not been administered any particular drug, for example. In this diagram, the brain scans in the top row will have a healthier color pattern. For example, the brain scan will have a predominantly blue region with only minor portions showing up in green and red.

In the middle row of brain scan diagrams, the diagrams show the brain of one or more patients that have taken drug A. Drug A can be, for example, an anti-depressant such as Prozac®. In this example, drug A produces a different brain scan than the brain scan shown for a patient that has not been administered any drugs. For example, the blue region of the brain scan is higher than that of the top row scans where the patient has not been administered any drugs. The brain scans in the middle row also have a lower green region than those of the top row.

The bottom row of brain scan diagrams shows the brain scans of one or more patients that have taken drug B. Drug B can be, for example, an antipsychotic drug such as Zyprexa®. In the example brain scans shown in the bottom row, drug B has a significantly different effect on the brain of the one or more patients being administered the particular drug. In this example, the brain scan shows blue, green, and red regions much like the brain scans shown in the top row. However, the green and red regions are much more pronounced than the ones shown in the top row. This could indicate that the particular drug is having an adverse effect on one or more patients and could help a doctor in prescribing another drug to treat the patient's condition.

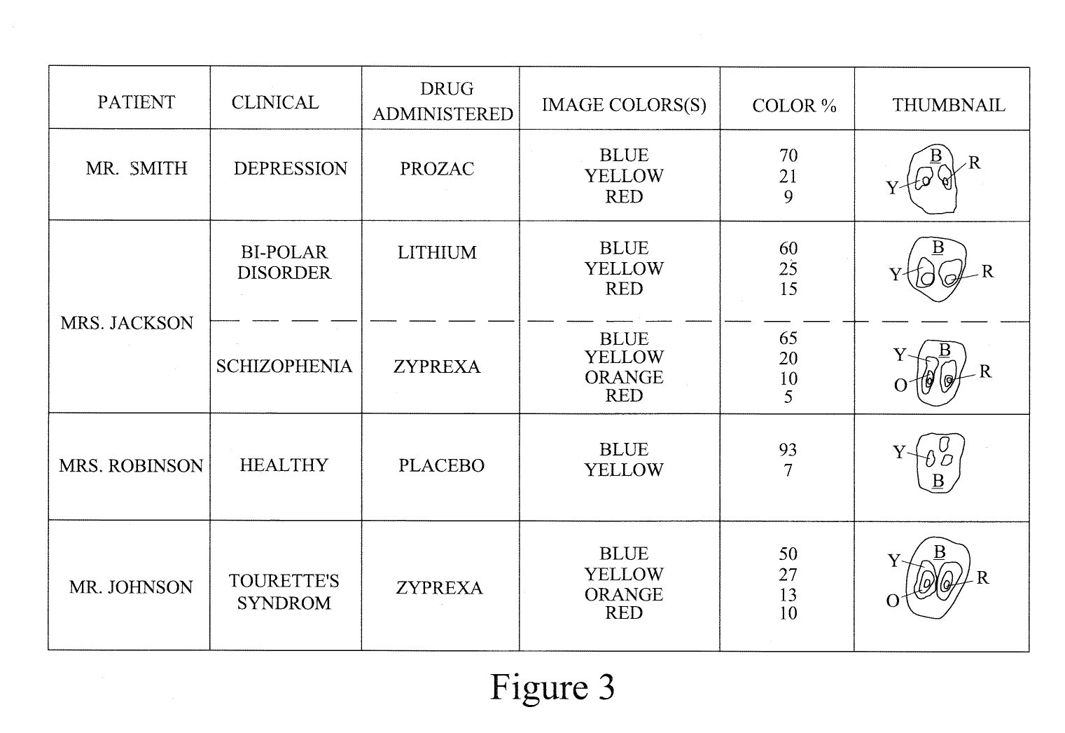

FIG. 3 shows a certain example embodiment of a table storing information in the medical image analysis system. This table can be stored in a medical database 301 of an information processing apparatus 300, as described further below. This information is collected from medical images taken from a variety of patients.

In the example shown in FIG. 3, the patients have received one or more clinical diagnoses and have been administered one or more drugs. Associated with the diagnosis and drug is a brain scan of the patient. As mentioned above, the brain scan will be color coordinated by different regions in the brain.

The table in FIG. 3 can identify which colors are present in the brain scan, and the percentage of the color found in various regions of the brain. For example, the patient identified as Mr. Smith has been clinically diagnosed with depression. A doctor has prescribed Prozac® for Mr. Smith, and prior to a medical imaging operation being performed on his brain, Mr. Smith has taken the drug. Data about the sizes, shapes, relative placements, superimpositions, etc., of the colors also may be stored.

In this example, Mr. Smith's brain scan has three predominant image colors: blue, yellow, and red. A thumbnail of the brain scan can be shown along with the identification of the image colors and the percentage of the colors in the region of the brain scan image. So for example, Mr. Smith's dosage of Prozac® is associated with his brain scan showing a 70% blue region, a 21% yellow region, and a 9% red region. It should be appreciated that a brain scan of Mr. Smith may be taken before he is administered any particular drug. In that way, medical personnel will be able to determine how the medication affects Mr. Smith's brain scan data. Similarly, a collection of brain scans with Mr. Smith's same diagnosis (i.e., depression) can be used to help medical personnel identify a diagnosis, or at least narrow down a diagnosis, from brain scans alone. Thus, it will be appreciated that “before and after” images may be taken in some cases, and/or multiple before and/or after images may be taken to track the progress of the patient throughout a treatment regimen. This data may be used to help determine improving/declining efficacy, so-called peaks in the treatment, etc., and also may be used to help identify telltale signs of the same.

The information stored in the medical database 301, can help medical personnel use this information to link a brain scan to a particular clinically diagnosed disease and help determine which medications will likely be useful for treating the disease without any particular adverse impact on the brain. For example, a brain scan of an undiagnosed patient may be similar to that of Mr. Smith (or similarly diagnosed patients). A doctor can enter the patient's brain scan into the medical database 301 and the system will compare the brain scan data using the image colors and color percentages, locations, sizes, shapes, etc., in one or more particular regions of the brain scan to help the doctor diagnose the patient's mental illness. The system may be able to single out a disease or may narrow the doctor's search to a select few possible diseases (e.g., depression, anti-social personality disorder, bipolar disorder). Likewise, the medical database 301 can show the particular drugs that were used on the patients and help determined which drugs produced the “healthiest” brain scans. For example, a patient with depression using Prozac® may have significantly higher blue regions than patients using Lexapro®. Therefore, a doctor may determine that patients with depression likely may have more success with Prozac® than Lexapro®.

It should be appreciated that the information shown in FIG. 3 is only for example, and significantly more information regarding the patient, the diagnosis, and drug use can be provided. For example, the patient's data can also include demographics such as gender, race, age, height, weight, eating/drinking habits, etc. Likewise, results from blood work and/or analysis of chemicals in the brain, and data from genetic testing can be incorporated into the information shown in FIG. 3. For example, clusters of blood work, chemicals in the brain, hormones generated by the patient, results from genetic testing, and/or results from DNA testing can be incorporated into the information for providing a baseline for analysis. This information can further help medical personnel diagnose a particular condition and determine which drugs will be useful for an individual. In general, a database of factors relevant to diagnosing different diseases may be stored such that they are linked to images and/or data related to those images.

As discussed above, a patient can be diagnosed with one or more illnesses and his/her brain scans can be stored based on the particular use of one or more drugs. For example, FIG. 3 shows patient Mrs. Jackson having a clinical diagnoses of bipolar disorder and schizophrenia. Like Mr. Smith, Mrs. Jackson may have a brain scan on file (not shown) that is taken before the use of any drugs.

In this example, after Mrs. Jackson is administered Lithium®, a brain scan can be taken to show the drug's effect on her brain. Here, an entry will be entered for Mrs. Jackson showing her clinical diagnosis for bipolar disorder, the administration of Lithium®, and a brain scan thumbnail where image colors show blue, yellow, and red at 60%, 25%, and 15%, respectively.

The system can also be configured to show multiple brain scans for multiple clinical diagnoses and/or multiple administration of drugs. In this example, Mrs. Jackson is also diagnosed with schizophrenia. After the administration of Zyprexa®, another brain scan has been taken and entered into the database 301. Here, the brain scan shows blue, yellow, orange, and red regions at 65%, 20%, 10%, and 5%, respectively.

Once again, a doctor can use this region to not only help diagnose a patient's medical condition, but also to determine which medications likely will be useful in treating the patient. For example, certain brain scan data can be “pooled” together with other brain scan data to help narrow clinical diagnoses. The brain scan data can also be “pooled” to determine which particular drugs have certain side effects on a patient. For example, a drug may consistently produce brain scans with heightened red regions, thereby indicating that the drug is causing an imbalance in the physical tissue of the patient's brain. As more data is collected, patterns in disease diagnosis, treatment regimens, and drug effectiveness can be identified, and best practices or most likely best candidates for treatments and/or expectations for success can be suggested or calculated. Diseased and treated image templates can be created and compared over time for these and/or other purposes.

It should also be appreciated that brain scan data can be entered for healthy patients. For example, in FIG. 3 Mrs. Robinson is clinically diagnosed as healthy and has been administered a placebo. Her brain scan thumbnail is entered showing blue and yellow regions at 93% and 7%, respectively. Mrs. Robinson's brain scan can then be used later should she be clinically diagnosed with a particular illness. Her brain scan will have a “healthy” template to work from so that a doctor can provide a clinical diagnosis and/or determine which drugs are working or having adverse effects on her.

It should be appreciated that the example in FIG. 3 are for purposes of illustration and are not limited to this particular embodiment. For example, additional information can be provided, such as the duration the patient has been diagnosed with the condition/illness, the duration of treatment with a particular drug, multiple brain scans over different periods of time, etc.

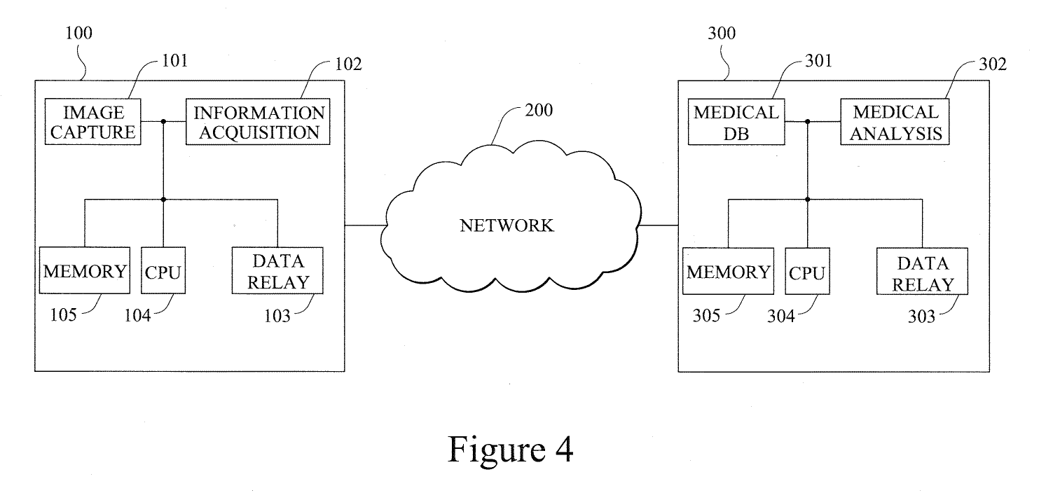

FIG. 4 shows a block diagram of a certain example embodiment. In FIG. 4, a medical imaging system 100 communicates with an information processing apparatus 300. In certain embodiments the medical imaging system 100 will communicate with the information processing apparatus 300 over a network 200. The connection to the network by each device may be wired or wireless. It should also be appreciated that the medical imaging system 100 can communicate with the information processing apparatus 300 using portable memory media, such as a USB memory key, flash drive, or the like. Also, the information processing apparatus 300 may be integrated into the medical imaging system 100 so that the two devices will not have to communicate over any particular medium.

As shown in FIG. 4, the medical imaging system 100 may have an image capture unit 101, an information acquisition unit 102, a data relay unit 103, a CPU 104, and a memory 105. The image capture unit 101 can be any image capturing device, such as a camera or an array of cameras. The image capture unit 101 can be configured to capture the exterior of a patient's body and also the interior (e.g., organs) of the patient's body. In certain example embodiments, the image capture unit 101 can capture a scan of a patient's brain.

The medical imaging system 100 can also be configured to obtain patient and other information using the information acquisition unit 102. In certain example embodiments, a user can enter information about the patient, such as the patients, name, clinical diagnosis, drugs administered, age, gender, etc. It should be appreciated that this information may also be acquired separate from the medical imaging system 100 and can be directly entered into the information processing apparatus 300.

The medical imaging system 100 also has a CPU 104 for executing functions related to the image capture unit 101 and the information acquisition unit 102 and a memory 105 for storing data in the medical imaging system 100. For example, the memory 105 may contain information acquired from the information acquisition unit 102 or image data acquired from the image capture unit 101.

The medical imaging system 100 also has a data relay unit 103 for relaying data to another device, such as the information processing apparatus 300. In an example embodiment, the data relay unit 103 is a form of wireless communication that can communicate with a wireless network, such as a wireless LAN or a data cellular network. However, the data relay unit 103 is not limited to this embodiment and can be wired, as well. Furthermore, the data relay unit 103 may also be a medium for transmitting data using a portable electronic memory device, such as a USB memory key.

In certain embodiments, medical information is relayed from the medical imaging system 100 to the information processing apparatus 300. Similar to the medical imaging system 100, the information processing apparatus 300 has a data relay unit 303, a CPU 304, and a memory 305.

Like data relay unit 101, data relay unit 303 can be a form of wireless communication that can communicate with a wireless network, such as a wireless LAN or a data cellular network. However, the data relay unit 303 is not limited to this embodiment and can be wired, as well. Furthermore, the data relay unit 303 may also be a medium for transmitting data using a portable electronic memory device, such as a USB memory key.

The CPU 304 and the memory 305 are used in conjunction with operations related to processing medical information in a medical database 301 and a medical analysis unit 302. The medical database 301 can store information acquired from the image capture unit 101 and the information acquisition unit 102 in the medical imaging system 100. The medical analysis unit 302 can thus be configured to correlate this information to aid medical personnel in making clinical diagnoses and/or determining which drugs are suitable for a particular patient.

The medical analysis unit 302 can also be configured to provide a reporting tool for informational purposes or for diagnoses. For example, a doctor may perform imaging on the brain of a patient and then submit the brain scan to the information processing apparatus 300. The medical analysis unit 302 may be configured to help identify or reduce the field of possible diagnoses based on the brain scan and also provide information as to what drugs might be useful in treating the conditions. The report can be submitted to the doctor in many forms. For example, the doctor may be able to retrieve the report using a computing device such as a personal computer, PDA, cell phone, etc. The information may also be displayed on a display on the medical imaging system 100. The report may also be sent by facsimile communication to the doctor for analysis.

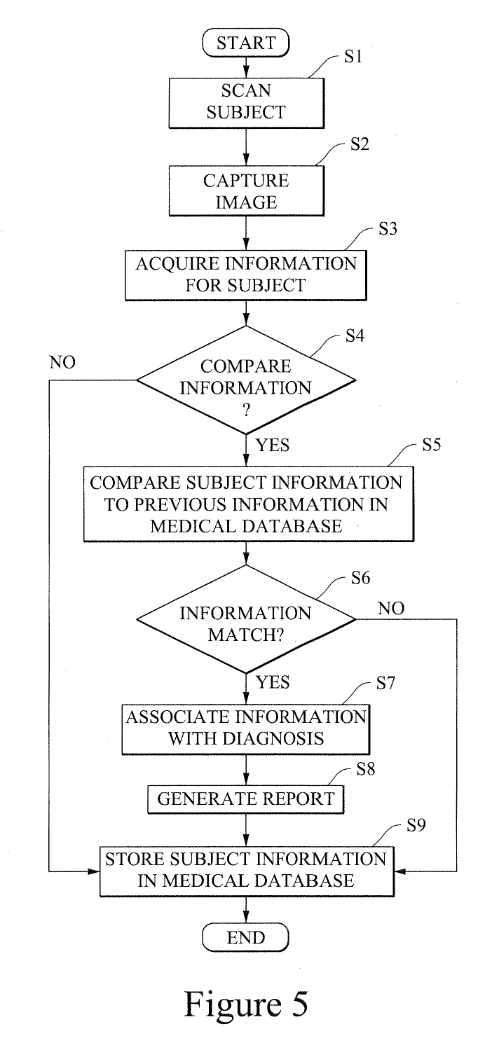

FIG. 5 shows an application flowchart for a certain example embodiment of the present system. The system begins in step S1 where a subject/patient is scanned by the medical imaging system 100, for example.

After the patient is scanned in step S1, the system proceeds to step S2 where medical image(s) are captured of the patient. As explained above, the medical image(s) can be acquired using the image capture unit 101 in the medical imaging system 100. The medical imaging technology can be a PET scan, CT scan, MRI, ultrasound, or the like, for example.

After the medical image is captured, the system proceeds to step S3 where information regarding the subject/patient are acquired. This information can be acquired, for example, by a user entering the information into a personal computing device. Of course, other methods for acquiring this information are also available. For example, the subject/patient may have some sort of identification device (e.g., health insurance card, RFID tag, medical bracelet) that can link the subject/patient to medical history and/or demographic information relating to the subject/patient.

After acquiring the information in step S3, the system proceeds to step S4 where it is determined whether the medical image data and the acquired information should be compared to medical information stored in an information processing apparatus 300. More specifically, medical personnel may decide to forego some analysis and simply store the information in a medical database. If that is the case, the system proceeds to step S9 where the medical image data and the subject/patient information are stored in the medical database 301.

If it is decided to compare the image data and the subject/patient information to data stored in the medical database 301, the system proceeds to step S5 where it compares the information obtained to data collected and already stored in the medical database 301. For example, this comparison can help medical personnel diagnose a patient with a clinical illness or can help determine which medication is appropriate for a particular patient based on the medical image data.

In step S6 the system determines if the acquired image data and information for the subject/patient matches data or sets of data stored in the medical database 301. If there is no match, the system proceeds to step S9 where it stores the subject's information into the medical database 301 and reports to the user that there is currently no match for this data.

If there is a match, the system proceeds to step S7 where it can identify or limit the set of potential diagnoses for a subject. Likewise, the system can determine which medication(s) would be useful in treating the particular condition(s).

After the data has been matched and associated with one or more conditions and/or one or more medications, the system proceeds to step S8 where it will generate a report for the medical personnel to use for aiding in the diagnosis and/or determining which medications are useful for a particular patient. The report can include any sort of information helpful in aiding medical personnel.

After generating the report in step S8, the system proceeds to step S9 where the medical image data and subject/patient information are stored in the medical database 301. This information can be added to the collective information already stored for helping diagnose future illness or for any other statistical or reporting purposes.

It should be appreciated that the steps mentioned above may be executed in any particular order and are not limited to the order shown in the flowchart. It should also be appreciated that these steps may be performed on the medical imaging system 100, the information processing apparatus 300, or any other computing device.

While the system has been described in connection with what is presently considered to be the most practical and preferred embodiment, it is to be understood that the system is not to be limited to the disclosed embodiment, but on the contrary, is intended to cover various modifications and equivalent arrangements included within the spirit and scope of the appended claims.

What is claimed is:

1. A method for analyzing medical image data using a computer processing system having one or more processors, the method comprising:
acquiring medical image data of a first subject;
acquiring medical information related to the first subject;
associating the medical information and the medical image data with a drug used by the first subject;
comparing the medical image data, the medical information, and the drug used to stored medical image data, stored medical information, and stored drug use of a second subject;
determining if the medical image data, the medical information, and the drug used match the stored medical image data, the stored medical information, and the stored drug use of the second subject; and
generating a report for diagnosing/treating the first subject based on the determined match.

2. The method according to claim 1, wherein the medical image data of the first subject is acquired by scanning the first subject using a scanning device and capturing the medical image data using the scanning device.

3. The method according to claim 1, wherein data corresponding to the medical image data, the medical information, and the drug used are stored in a medical database.

4. The method according to claim 3, wherein data corresponding to the medical image data, the medical information, and the drug used are stored in the medical database after the medical information and the medical image data are associated with the drug used by the first subject and without comparing, determining, or generating the report.

5. The method according to claim 1, wherein the report includes information relating to a subject name, a clinical diagnosis, a drug administered, image colors of the medical image data, percentage of image colors in the medical image data, and a thumbnail of the medical image data for the first and second subjects.

6. The method according to claim 2, wherein the scanning device is at least one of a PET scanning device, a CT scanning device, and an MRI scanning device.

7. A non-transitory computer-readable storage medium having computer readable code embodied therein for executing the method for analyzing medical image data of claim 1.

8. A medical imaging analysis system for analyzing medical image data, comprising:
a scanning device; and
an information processing device;
the scanning device including:
an image capture unit for capturing image data of a first subject; and
a data relay unit configured to relay the captured image data, and the information processing device including:
a data relay unit configured to receive the relayed captured image data,
a memory for storing a medical database, and
a medical analysis unit having one or more processors and configured to:
acquire medical image data of the first subject;
acquire medical information related to the first subject;
associate the medical information and the medical image data with a drug used by the first subject;
compare the medical image data, the medical information, and the drug used to stored medical image data, stored medical information, and stored drug use of a second subject;
determine if the medical image data, the medical information, and the drug used match the stored medical image data, the stored medical information, and the stored drug use of the second subject; and
generate a report for diagnosing/treating the first subject based on the determined match.

9. The medical imaging analysis system according to claim 8, wherein data corresponding to the medical image data, the medical information, and the drug used are stored in the medical database after the medical information and the medical image data are associated with the drug used by the first subject and without comparing, determining, or generating the report.

10. The medical imaging analysis system according to claim 8, wherein the report includes information relating to a subject name, a clinical diagnosis, a drug administered, image colors of the medical image data, percentage of image colors in the medical image data, and a thumbnail of the medical image data for the first and second subjects.

11. The medical imaging analysis system according to claim 8, wherein the scanning device is at least one of a PET scanning device, a CT scanning device, and an MRI scanning device.

12. The medical imaging analysis system according to claim 8, wherein the medical information is acquired at the scanning device, the scanning device relaying both the medical image data and the medical information to the information processing device.

13. The medical imaging analysis system according to claim 8, wherein the medical information is acquired at the information processing device.

14. An information processing device used for analyzing medical image data, the information processing device comprising:
a data relay unit configured to receive captured image data relayed from an image capturing device;
a memory for storing a medical database; and
a medical analysis unit having one or more processors and configured to:
acquire medical image data of a first subject;
acquire medical information related to the first subject;
associate the medical information and the medical image data with a drug used by the first subject;
compare the medical image data, the medical information, and the drug used to stored medical image data, stored medical information, and stored drug use of a second subject;
determine if the medical image data, the medical information, and the drug used match the stored medical image data, the stored medical information, and the stored drug use of the second subject; and
generate a report for diagnosing/treating the first subject based on the determined match.

15. The information processing device according to claim 14, wherein the medical image data of the first subject is acquired by scanning the first subject using a scanning device and capturing the medical image data using the scanning device.

16. The information processing device according to claim 14, wherein data corresponding to the medical image data, the medical information, and the drug used are stored in the medical database after the medical information and the medical image data are associated with the drug used by the first subject and without comparing, determining, or generating the report.

17. The information processing device according to claim 14, wherein the report includes information relating to a subject name, a clinical diagnosis, a drug administered, image colors of the medical image data, percentage of image colors in the medical image data, and a thumbnail of the medical image data for the first and second subjects.

18. The information processing device according to claim 15, wherein the scanning device is at least one of a PET scanning device, a CT scanning device, and an MRI scanning device.

19. A method of diagnosing a patient, the method comprising:
receiving a scan of the patient's brain;
comparing, via at least one processor, the scan of the patient's brain to pre-treatment baseline scans of other patients' brains;
identifying one or more similar pre-treatment baseline scans;
determining one or more likely effective treatment regimens based on the one or more identified similar pre-treatment baseline scans; and
outputting data indicative of the one or more likely effective treatment regimens.

20. The method of claim 19, wherein the scan is a PET scan, and wherein the comparing is practiced by looking for similar color patterns as between the scan of the patient's brain and the pre-treatment baseline scans of the other patients' brains.
